(19) United States
(12) Patent Application Publication
(10) Pub. No.: US 2010/0315366 A1
(43) Pub. Date: Dec. 16, 2010

(54) METHOD FOR RECOGNIZING TOUCH INPUT IN TOUCH SCREEN BASED DEVICE

(75) Inventors: Sung Chan LEE, Gyeonggi-do (KR); Hyun Su KIM, Gyeonggi-do (KR); Young Soo YUN, Seoul (KR); Soo Hyeon LEE, Gyeonggi-do (KR)

Correspondence Address: Cha & Reiter, LLC, 17 Arcadian Avenue, Suite 208, Paramus, NJ, 07652, US

(73) Assignee: Samsung Electronics Co., LTD., Gyeonggi-Do (KR)

(21) Appl. No.: 12/813,703

(22) Filed: Jun. 11, 2010

(30) Foreign Application Priority Data
Jun. 15, 2009 (KR) 10-2009-0052634

(51) Int. Cl. G06F 3/041

(52) U.S. Cl. 345/173

(57) ABSTRACT

A method for recognizing touch input in a touch screen based device is provided. The method for recognizing touch includes: checking a location of the touch input when a touch is inputted; checking a changed location of the touch when a location of the touch is changed; and recognizing that the touch is released in the location of the touch input when touch release occurs in the changed location.

### CLAIM OF PRIORITY

This application claims the benefit under 35 U.S.C. §119(a) of a Korean patent application filed in the Korean Intellectual Property Office on Jun. 15, 2009 and assigned Serial No. 10-2009-0052634, the entire disclosure of which is hereby incorporated by reference.

### BACKGROUND OF THE INVENTION

1. Field of the Invention

The present invention relates to a method for recognizing touch input in a touch screen based device, and more particularly, to a method for compensating a location of touch when a location of touch input and a touch release differs from each other.

2. Description of the Related Art

In recent years, a portable terminal now provides all types of data transmission services, various multimedia services, and unique speech calling services.

With the development of a touch screen based portable terminal, research into touch user interface (UI) technology has been focused to enable various touch inputs. In general, a location on a touch screen used for the portable terminal is recognized according to x and y resistances when the user touches the touch panel. In operation, when a touch is input on a touch panel by means of a stylus pen or an object having a sharp point, a location of touch release, substantially corresponds to a location of touch input prior to the release. However, when the touch is input on the touch panel by a flexible plane such as a finger, the location of touch input and the location of touch release can be differ depending on angle of activation by the finger. For example, as shown in FIG. 6a, when the user inputs the touch, the user's finger is pressed on a part ‘x’. However, as shown in FIG. 6b, when the user releases the touch, the user can get off the finger from the touch screen at a part ‘o’. In this case, the portable terminal can recognize that the touch is input in coordinates other than the user's intention ‘x’. As a result, incorrect input can be recorded or activated.

### SUMMARY OF THE INVENTION

The present invention has been made in view of the above problems, and provides a method for compensating for a location of a touch when a location of touch release differs from the location of touch input.

In accordance with an aspect of the present invention, a method for recognizing touch input includes: checking a location of the touch input when a touch is input; checking a change in location of the touch from the beginning and at the end of the activation; and recognizing that the touch input is released at the location of the touch input when a touch release occurs within the location change.

In accordance with another aspect of the present invention, an apparatus screen based device includes: a touch sensor sensing touch input or touch release to generate a touch signal; and a controller receiving the touch signal from the touch sensor to check a location of the touch input and a changed location of a touch, and recognizing the touch is released in the location of the touch input when the touch is released in the changed location.

### BRIEF DESCRIPTION OF THE DRAWINGS

The above features and advantages of the present invention will be more apparent from the following detailed description in conjunction with the accompanying drawings, in which:

FIG. 1 is a block diagram illustrating a configuration of a portable terminal according to an exemplary embodiment of the present invention;

FIG. 2 is a flow chart illustrating a method for recognizing touch input in a touch screen based device according to a first embodiment of the present invention;

FIG. 3 is a view illustrating a threshold distance for discriminating a drag operation according to an embodiment of the present invention;

FIG. 4a is a view illustrating an example of an application display screen to which a method for recognizing touch input in a touch screen based device according to another embodiment of the present invention is applied;

FIG. 4b is a view illustrating a screen obtained by corresponding a part (a) of the application display screen shown in FIG. 4a to coordinates;

FIG. 5 is a flow chart illustrating a method for recognizing touch input in a touch screen based device according to a second embodiment of the present invention; and

FIGS. 6a and 6b are views illustrating respective touch locations when a user touches on a touch screen and releases the touch from the touch screen a touch according to an embodiment of the present invention.

### DETAILED DESCRIPTION OF THE INVENTION

Hereinafter, exemplary embodiments of the present invention are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

The term ‘touch input’ according to an embodiment of the present invention means an operation that a user presses a touch screen by a touch means (fingers, etc.). The term ‘touch release’ according to an embodiment of the present invention means an operation that the user gets off the touch means from the touch screen.

A portable terminal is described in an embodiment of the present invention by way of example, thus should not limit the scope of the invention. The present invention is applicable to large display devices such as a TV, a computer, or a notebook computer. Further, a portable terminal according to an embodiment of the present invention is a terminal having a touch screen, which is applicable to information communication devices or multimedia devices such as mobile communication terminal, portable multimedia player (PMP), personal digital assistant (PDA), smart phone, or MP3 player, and application thereof.

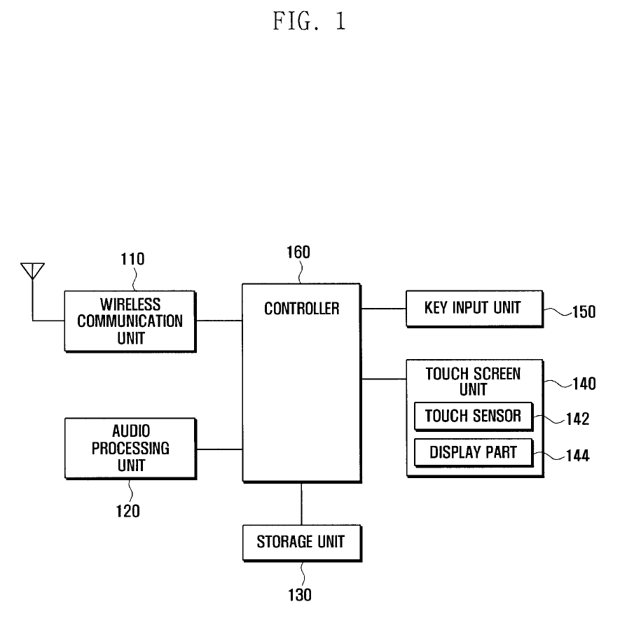

FIG. 1 is a block diagram illustrating a configuration of a portable terminal according to an exemplary embodiment of the present invention.

A wireless communication unit 110 performs transmitting and receiving functions of corresponding data for wireless communication of the portable terminal. The wireless communication unit 110 includes an RF transmitter up-converting the frequency of a signal to be transmitted and amplifying the signal, and an RF receiver low-noise amplifying a received signal and down-converting the frequency of the amplified signal. Further, the wireless communication unit 110 may receive data through a wireless channel and outputs it to a controller 160, and transmit data output from the controller 160 through the wireless channel.

An audio processing unit 120 can be configured by coder/decoder (CODEC). The CODEC includes a data CODEC processing packet data and the like, and an audio CODEC processing an audio signal such as voices and the like. The audio processing unit 120 converts a digital audio signal into an analog audio signal using the audio CODEC, and reproduces the analog audio signal through a speaker (SPK). Furthermore, the audio processing unit 120 converts an analog audio signal input from a microphone (MIC) into a digital audio signal using the audio CODEC.

A storage unit 130 functions to store programs and data necessary for an operation of the portable terminal, and can be divided into a program area and a data area. The storage unit 130 according to an embodiment of the present invention stores a program for recognizing a user's touch input and touch release. Moreover, the storage unit 130 may store information regarding a threshold distance recognized as a drag operation. The storage unit 130 may store a coordinate range of each division region and information regarding execution function at the touch time of the division region where a total touch region is divided into plural division regions. The storage unit 130 may store information about a division region for every application.

A touch screen unit 140 includes a touch sensor 142 and a display part 144. The touch sensor 142 senses whether a touch means is touched on a touch screen. A user's finger or a touch pen (stylus pen) can be used as the touch means. The touch sensor 142 may be configured by a capacitive overlay type, a pressure resistive overlay type, or an infrared beam type touch sensor, or a pressure sensor. It should be noted that other types of sensors capable of sensing touch of an object or pressure can be used as the touch sensor 142 of the present invention. The touch sensor 142 may be attached to the display part 144.

Meanwhile, the touch sensor 142 may be formed at one surface or one side of the portable terminal. The touch sensor 142 senses a user's touch input to the touch screen, and generates and transmits a touch signal to the controller 160. In this case, the touch signal may contain location information of touch input. The touch sensor 142 according to an embodiment of the present invention senses touch release, and generates and transmits a touch signal containing location information of touch release to the controller 160. In addition, the touch sensor 142 senses a location change of the touch input and generates a touch signal containing a changed touch location information to the controller 160.

The display part 144 may be configured by a liquid crystal display (LCD). The display part 144 visibly provides various information such as menus, input data, and function set information of the portable terminal to a user. For example, the display part 144 performs a function outputting a booting screen, an idle screen, a display screen, a calling screen, and application execution screens. The display part 144 according to an embodiment of the present invention displays images stored in the storage unit 130 under the control of the controller 160. Alternatively, the display part 144 may separately display respective division regions when a total touch region is divided into plural division regions.

A key input unit 150 receives input of a user's key operation signal for controlling the portable terminal, and transfers it to the controller 160. The key input unit 150 may be configured by a keypad including numeric keys and direction keys. The key input unit 150 can be formed by predetermined function keys installed at one surface of the portable terminal. In an alternate embodiment, the key input unit 150 can be omitted if touch sensor 142 provides the input means thereon.

The controller 160 performs the overall operation of the portable terminal. The controller 160 according to an embodiment of the present invention receives the touch signal from the touch sensor 142 and checks a location of touch input. Further, the controller 160 receives a touch signal from the touch sensor 142 to check a changed location of the touch or a location of touch release. When it is checked that the touch is released in the changed location of the touch, the controller 160 recognizes that the touch is released in the location of the touch input. When a distance between the location of the touch input and the changed location of the touch is less than or equal to a preset threshold distance, the controller 160 according to an embodiment of the present invention recognizes that the touch is released in the location of the touch input.

In an embodiment of the present invention, a total region of the touch input is divided into plural division regions. In this case, the controller 160 recognizes the total region of the touch input to separately recognize the plural division regions. The controller 160 checks whether a division region having the changed location of the touch is identical with a division region having the location of the touch input. When touch release occurs in the changed location where the division region having the changed location of the touch differs from the division region having the location of the touch input, the controller 160 recognizes that the touch is released at the location of the touch input. Note that the teachings of the present invention relates to recognizing a touch location in the state when the touch panel is activated in order to determine an exact location of the release during operation.

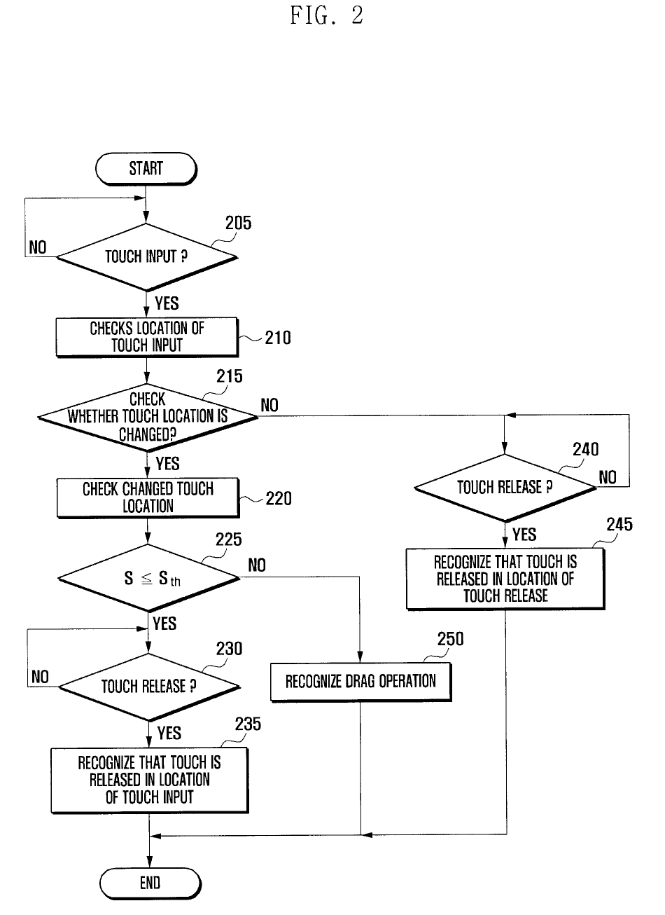

FIG. 2 is a flow chart illustrating a method for recognizing touch input in a touch screen based device according to a first embodiment of the present invention.

A controller 160 controls a touch sensor 142 to check whether a user inputs a touch (205). When the user inputs the touch, the touch sensor 142 generates and transfers a touch input signal to the controller 160. When the controller 160 receives the touch input signal from the touch sensor 142, it checks a location (x1, y1) of touch input (210). The touch sensor 142 according to an embodiment of the present invention may recognize the touch for each pixel. In this case, the touch sensor 142 generates a touch input signal containing information about coordinates of a pixel of the touch input, and transfers the touch input signal to the controller 160. The touch sensor 142 according to an embodiment of the present invention may recognize the touch in groups of a plurality of pixels. In this case, the touch sensor 142 generates a touch input signal containing information regarding coordinates of touch input in coordinates set at predetermined intervals. The controller 160 receives the touch input signal from the touch sensor 142 and checks a location (x1, y1) of the touch input.

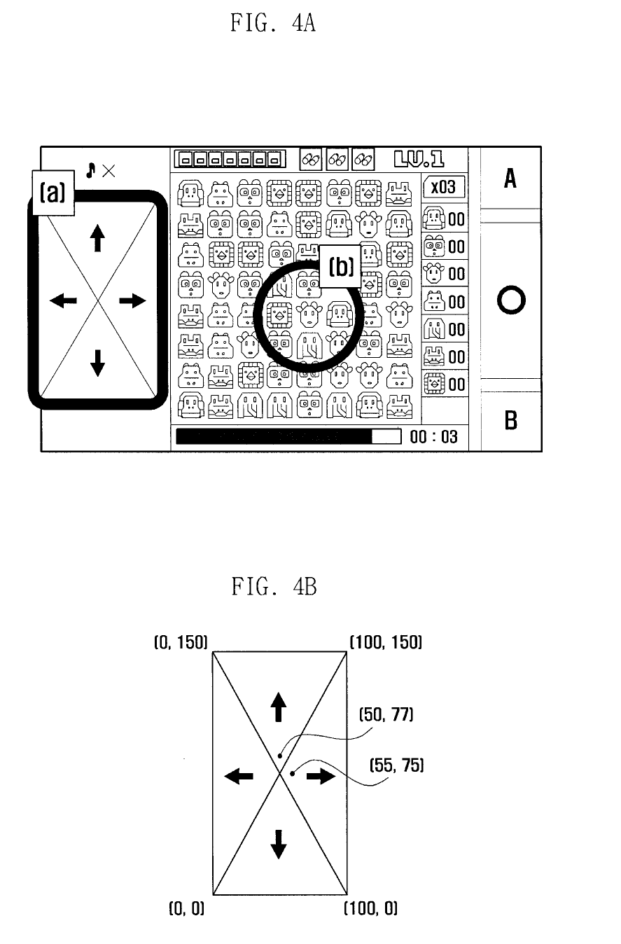

FIG. 4a is a view illustrating an example of an application display screen to which a method for recognizing touch input in a touch screen based device according to another embodiment of the present invention is applied. A display screen shown in FIG. 4a is a display screen of a game application by operating direction keys of (a) to move a circle (b). FIG. 4b is a view illustrating a screen obtained by corresponding a part (a) of the application display screen shown in FIG. 4a to coordinates. The screen of FIG. 4b is obtained by corresponding the part (a) of FIG. 4a to coordinates from (0, 0) to (100, 150). In the present invention, it is assumed that a user inputs a touch on a right direction key and the controller 160 recognizes a user's input coordinates with (55, 75).

Referring back to FIG. 2, the controller 260 controls the touch sensor 142 to check whether a location of the touch is changed (215). The touch sensor 142 senses the change in a location of the touch input, and generates and transfers a touch input signal to the controller 160. The touch input signal contains information regarding the changed location (x2, y2) of the touch. The controller 160 receives a touch input signal from the touch sensor 142 and checks the changed location (x2, y2) of the touch (220). Alternatively, referring to FIGS. 4a and 4b, a user moves a finger in a state that the touch is inputted on the touch screen, and the controller 160 recognizes that the location of the touch to be changed to (50, 77).

The controller 160 calculates a distance s between a location (x1, y1) of the touch input and a changed location (x2, y2) of the touch, and checks whether the calculated distance s is less than or equal to a preset threshold distance Sₜₕ (225). The threshold distance Sₜₕ in an embodiment of the present invention means a minimum moving distance to be recognized in a drag operation. For example, where the threshold distance Sₜₕ in the portable terminal is set to 18 pixels, when a user inputs a moving operation exceeding 18 pixels after the touch input, the controller 160 recognizes that a user's operation is a drag operation.

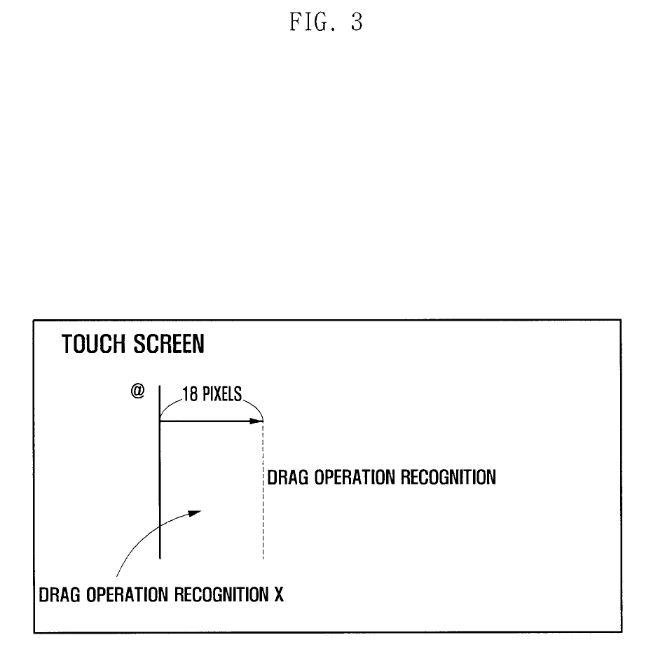

FIG. 3 is a view illustrating a threshold distance for discriminating a drag operation according to an embodiment of the present invention. Upon setting a @ to a reference line, when a user inputs a touch on the reference line and then moves the touch exceeding 18 pixels, the controller 160 recognizes that a user operation is a drag operation. Conversely, when the user moves the touch less than or equal to 18 pixels based on the reference line @, the controller 160 recognizes that the user operation is not the drag operation but a simple touch input. A moving operation can be classified into drag, move, and flick according to a moving time of the threshold distance Sₜₕ. The controller 160 may measure a moving distance together with moving speed to recognize that an input operation of the user is one of the drag, the move, and the flick. Referring to FIGS. 4a and 4b, the controller 160 calculates a moving distance s between coordinates (55, 75) and coordinates (50, 77), and checks whether the calculated moving distance s is less than or equal to the threshold distance Sₜₕ.

Referring back to FIG. 2, when the calculated moving distance s at step 225 is less than or equal to the threshold distance Sₜₕ, the controller 160 controls the touch sensor 142 to check whether touch release occurs (230). When the user releases a finger after the activation on the touch screen unit 140, the touch sensor 142 senses the occurrence of touch release, and generates and transfers a touch release signal to the controller 160. The touch release signal may contain information about an occurrence location of the touch release. The controller 160 receives the touch release signal from the touch sensor 142. The controller 160 recognizes that the touch is released in a location (x1, y1) of the touch input (235). Namely, the controller 160 recognizes that the touch release occurs in the location (x1, y1) of the touch input not a location (x2, y2) of the touch release. Alternatively, referring to FIGS. 4a and 4b, the controller 160 recognizes that the touch release occurs in coordinates (55, 75) not coordinates (50, 77).

When the controller 160 checks that the location of the touch is not changed, it controls the touch sensor 142 to check whether the touch release occurs (240). The touch sensor 142 generates and transfers a touch release signal to the controller 160. The controller 160 receives the touch release signal from the touch sensor 142, and checks a location (x2, y2) of the touch release. The controller 160 recognizes that the touch is released in the location (x2, y2) of touch release (245).

Meanwhile, when the controller 160 checks that the calculated moving distance s at step 225 exceeds the threshold distance Sₜₕ, the controller 160 recognizes that an input operation is a drag operation (250). In the embodiment, the controller 160 may measure an input time and recognize that a user' input operation is one of drag, move, and flick according to a measured result. The controller 160 may control the display part 144 to move and display a graphic user interface (GUI) corresponding to the drag operation.

In the embodiment, when the controller 160 receives a touch input signal and a touch release signal from the touch sensor 142 to check locations of touch input and release, and checks that a distance s between the locations of the touch input and release is less than or equal to the threshold distance Sₜₕ, the terminal may recognize that the touch is released in the location of the touch input.

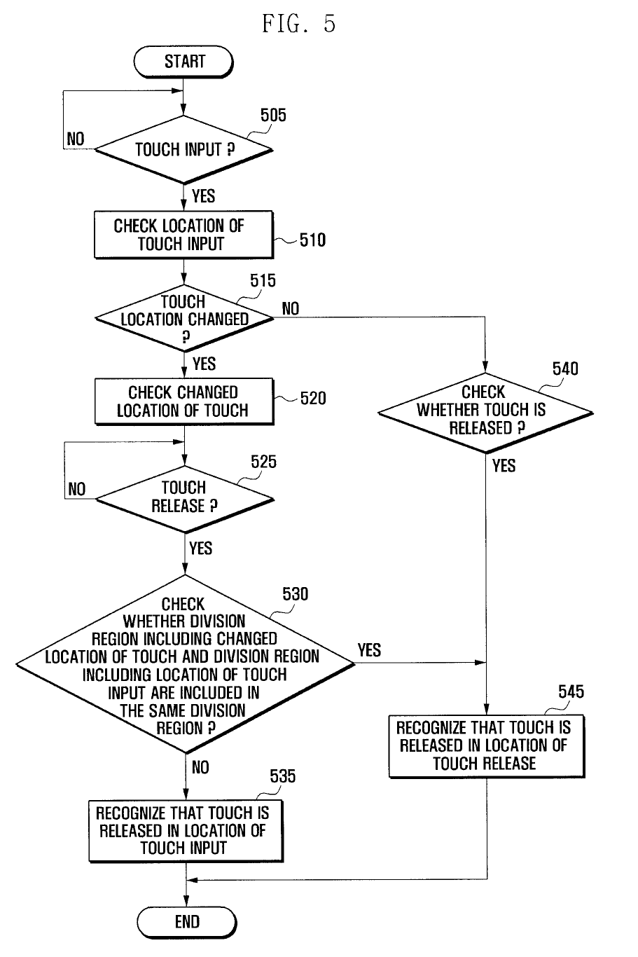

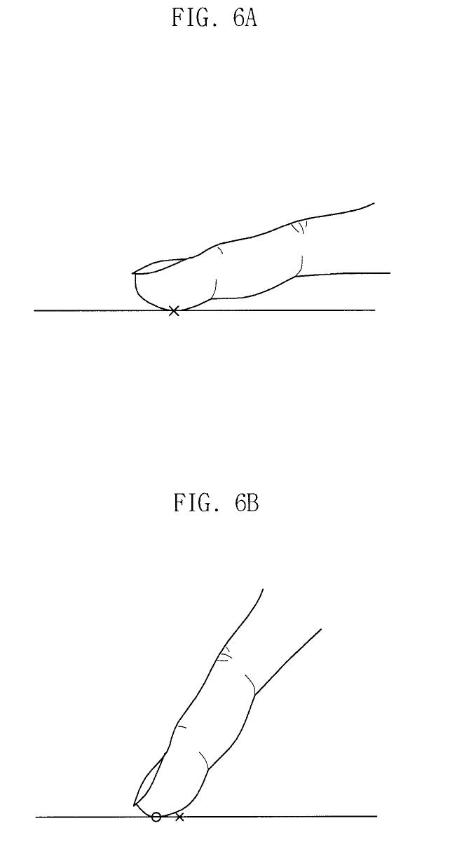

FIG. 5 is a flow chart illustrating a method for recognizing touch input in a touch screen based device according to a second embodiment of the present invention.

A controller 160 controls a touch sensor 142 to check whether a touch is inputted from a user (505). When the touch is inputted from the user, the touch sensor 142 generates and transfers a touch input signal to the controller 160. When the controller 160 receives the touch input signal from the touch sensor 142, it checks a location (x1, y1) of touch input (510). In an embodiment of the present invention, when a display part 144 is divided into an operation region and a display region and the operation region is divided into a number of division regions, the controller 160 may check which division region is the location (x1, y1) of the touch input included. Referring to FIGS. 4a and 4b, a region (a) is the operation region, and a region (b) is a display region. Further, the operating region (a) is further divided into an upward region, a downward region, a left direction region, and a right direction region. Referring to FIG. 4b, the region (a) includes an upward triangle region formed by three apexes (0, 150), (100, 150), and (50, 75), a downward triangle region formed by three apexes (0, 0), (0, 150), and (50, 75), and a right direction region formed by three apexes (100, 0), (100, 150), and (50, 75). For illustrative purpose, when a user input a touch on a right direction key and a controller 160 recognizes that a user' input coordinates are (55, 75). In the embodiment of the present invention, after checking coordinates (55, 75), the controller 160 can recognize that a location of the touch input is included in the right triangle region.

The controller 160 controls the touch sensor 142 to check whether a location of the touch is changed (515). The touch sensor 142 senses change in the location of the touch input, and generates and transfers a touch input signal to the controller 160. The controller 160 receives the touch input signal from the touch sensor 142 to check the changed location (x2, y2) of the touch (520). Referring to FIGS. 4a and 4b, it is assumed that a user moves a finger in a state that the touch is inputted on a touch screen, and the controller 160 recognizes that the location of the touch is changed to coordinates (50, 77). Hence, the controller 160 may check the coordinates (50, 77) and then recognize that the input location of the touch is included in an upward triangle region.

The controller 160 controls the touch sensor 142 to check whether touch release occurs (525). The touch sensor 142 generates and transfers a touch release signal to the controller 160. The controller 160 receives the touch release signal from the touch sensor 142 to recognize that the touch is released.

The controller 160 checks whether a division region including the changed location of the touch checked at step 520 and a division region including the location of the touch input checked at step 510 are included in the same division region (530). The ‘same division region’ in an embodiment of the present invention means a region of a range set to execute the same function at the time of touch occurrence.

Referring to FIGS. 4a and 4b, the controller 160 recognizes that the location of the touch input is coordinates (55, 75), and then is included in the right triangle region at step 510. The controller 160 recognizes that the changed location of the touch is coordinates (50, 77) at step 520, and then is included in the upward triangle region at step 520. In this case, the controller 160 does not check that a region having a changed location of the touch and the location of the touch input are included in the same region. Rather, the controller 160 recognizes that the touch is released in the location (x1, y1) of touch input (535). Referring to FIGS. 4a and 4b, the controller 160 recognizes that the touch is released in coordinates (55, 75). Namely, the controller 160 recognizes that a moving operation of a touch location is an operation that a user did not intended during activation and release, and recognizes that the touch is released in first touch input other than a location at the time of touch release.

When it is checked that the location of the touch input is coordinates (55, 75) and the changed location of the touch is coordinates (57, 75), the two coordinates are determined to be included in a right direction triangle region as stated above, which is the same division region. In this case, the controller 160 checks that a division region including the changed location of the touch and a division region including the location of the touch input are included in the same region at step 530. In this case, the controller 160 checks that the touch is released in the released location thereof at step 545.

When the touch location is not changed at step 515, the controller 160 controls the touch sensor 142 to check whether the touch is released (540). When the touch is released, the controller 160 recognizes that the touch is released in the location of touch released (545).

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method for recognizing a touch input, comprising:
checking a location of the touch input when a touch input is activated on a touch screen;
determining a change in the location of the touch input from the beginning and at the end of the activation; and
recognizing that the touch input is released at the beginning of the activation when a touch release occurs within the determined change in the location of the touch input.

2. The method of claim 1, wherein the recognizing step comprises checking whether a distance between the location of the touch input the beginning and at the end of the activation is less than or equal to a preset threshold value.

3. The method of claim 2, wherein recognizing that the touch input is released at the beginning of the activation when the distance between the location of the touch input the beginning and at the end of the activation is less than or equal to the preset threshold value.

4. The method of claim 3, wherein recognizing that the touch input is a drag operation when the distance between the location of the touch input from the beginning and at the end of the activation is greater than the preset threshold value.

5. The method of claim 1, wherein a total region of the touch input is divided into a plurality of division regions.

6. The method of claim 5, wherein the recognizing step comprises checking whether a division region between the location of the touch input from the beginning and at the end of the activation is identical.

7. The method of claim 6, wherein recognizing that the touch input is released at the beginning of the activation when the division region between the location of the touch input the beginning and at the end of the activation is identical.

8. A screen based device, comprising:
a touch sensor that senses a touch input or a touch release to generate a touch signal; and
a controller, in response to the touch signal, determines a change in location of the touch input and the touch release, and recognizes that the location of the touch release occurs at the location of the touch input when the touch release occurs within the determined change.

9. The screen based device of claim 8, wherein the controller checks whether a distance between the location of the touch input and the location of the touch release is less than or equal to a preset threshold value.

10. The screen based device of claim 9, wherein the controller recognizes that the touch input is a drag operation when the distance between the location of the touch input and the location of the touch release is greater than the preset threshold value.

11. The screen based device of claim 8, wherein the controller recognizes that the location of the touch release occurs at the location of the touch input if the location of the touch input and the location of the touch release falls within a particular division.

12. A method for recognizing a touch input, comprising:
checking a location of the touch input when a touch is activated on a touch screen;
determining a changed location of the touch when a location of the touch is changed; and
recognizing that the touch is released in the location of the touch input when a touch release occurs in the changed location.

13. The method of claim 12, further comprising checking whether a distance between the location of the touch input and the changed location is less than or equal to a preset threshold distance,
wherein recognizing that the touch is released in the location of the touch input comprises recognizing that the touch is released in the location of the touch input when touch release occurs in the changed location where the distance between the location of the touch input and the changed location is less than or equal to the preset threshold value.

14. The method of claim 12, further comprising checking whether a division region having the changed location is identical with a division region having the location of the touch input, a total region of the touch input is divided into plural division regions,
wherein recognizing that the touch is released in the location of the touch input comprises recognizing that the touch is released in the location of the touch input when the touch release occurs in the changed location where the division region having the changed location differs from the division region having the location of the touch input.
